(19) United States
(12) Patent Application Publication
(10) Pub. No.: US 2007/0155855 A1
(43) Pub. Date: Jul. 5, 2007

(54) Method for treating particulate pigments

(75) Inventors: Ulrike Hees, Mannheim (DE); Michael Kluge, Worms (DE); Friedrich-Wilhelm Raulfs, Mannheim (DE); Holger Schopke, Neckargemund (DE); Karl Siemensmeyer, Frankenthal (DE); Richard van Gelder, Speyer (DE); Jurgen Weiser, Schriesheim (DE); Heinz Heissler, Frankenthal (DE); Stefan Adams, Ludwigshafen (DE); Gunter Renz, Freinsheim (DE); Paul Andrew Simpson, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/562,466

(22) PCT Filed: Jun. 11, 2004
(86) PCT No.: PCT/EP04/06298

§ 371 Date: Oct. 11, 2006

(30) Foreign Application Priority Data
Jun. 25, 2003 (DE) 10328716.7
Jul. 4, 2003 (DE) 10330412.6
Sep. 2, 2003 (DE) 10340777.4

(51) Int. Cl. C09D 11/00

(52) U.S. Cl. 523/160; 523/161

(57) ABSTRACT

A process for treating pigments in particulate form, comprising the following steps a) mixing pigment in particulate form with at least one nonionic surface-active substance, b) dispersing the thus obtainable mixture of pigment in particulate form and nonionic surface-active substance in an aqueous medium, c) addition polymerizing at least one first monomer or addition copolymerizing a first mixture of comonomers in the presence of a dispersion obtained after b) to form water-insoluble polymer or copolymer at the surface of the pigments in particulate form, d) adding at least one second monomer or a second mixture of comonomers and addition polymerizing or copolymerizing.

The present invention relates to a process for treating pigments in particulate form, comprising the following steps:
a) mixing pigment in particulate form with at least one nonionic surface-active substance,
b) dispersing the thus obtainable mixture of pigment in particulate form and nonionic surface-active substance in an aqueous medium,
c) addition polymerizing at least one first monomer or addition copolymerizing a first mixture of comonomers in the presence of a dispersion obtained after b) to form water-insoluble polymer or copolymer at the surface of the pigments in particulate form,
d) adding at least one second monomer or a second mixture of comonomers and addition polymerizing or copolymerizing.

The invention further relates to the use of inventively treated pigments in particulate form for producing colorant preparations, especially for producing inks for the ink jet process, and also a process for printing sheetlike or three-dimensionally configured substrates, especially textile substrates, in an ink jet process which employs the inventive inks. The present invention finally relates to substrates printed with the inventive inks.

Colorant preparations which are to be used in state of the art processes for coloring substrates have to meet demanding requirements. Colored substrates shall exhibit colors of high brilliance and the coloring shall be durable, i.e., have high fastnesses such as rubfastness for example.

High requirements apply particularly to colorant preparations which are used as or for producing inks which are to be used in the ink jet process (such as Thermal Ink Jet, Piezo Ink Jet, Continuous Ink Jet, Valve Jet, transfer printing processes). They have to have viscosity and a surface tension suitable for printing, they have to be stable in storage, i.e., they should not coagulate or flocculate, and they must not lead to cloggage of printer nozzles, which can be problematical especially in the case of inks containing dispersed, i.e., undissolved, colorant particles. Stability in storage further requires of these inks that the dispersed colorant particles do not sediment. Furthermore, in the case of Continuous Ink Jet, the inks shall be stable to the addition of conducting salts and be free from any tendency to floc out with an increase in the ion content. In addition, the prints obtained have to meet colorists' requirements, i.e., show high brilliance and depth of shade, and have good fastnesses, for example rubfastness, lightfastness, waterfastness and wetrubfastness, washfastness and stability to chemical drycleaning.

It is a further requirement that inks dry rapidly on the substrate in order that images or characters to be printed do not bleed and for example the ink droplets of different colors do not mingle. The production of needle-sharp prints requires in this connection not only print dry time minimization but also bleed control for the ink droplets on the substrate during the print dry time. An ink where the droplets do not bleed is said to have good holdout.

Rubfastnesses of colorant preparations and especially inks for the ink jet process are in many cases improved by using a binder which is applied after printing or used as an ingredient in the colorant preparation or ink and is printed together with the actual colorant preparation or ink, see for example WO 99/01516, p. 14 ff.

In some cases, however, the brilliance of colorations leaves something to be desired. An example of a case where brilliance of coloration leaves something to be desired is the application of binder-containing colorant preparations when it is desired to produce trichromats. Pigments are frequently observed to migrate after application, and needle-sharp images are either not sufficiently permanent or impossible to achieve in the first place. Moreover, the tactility of printed substrates could do with improvement in some cases, since it is desirable that printed substrates and especially textile substrates have a pleasantly soft hand and should not become stiff as a result of printing.

There have been attempts to treat pigments by coating them with a polymer. U.S. Pat. No. 3,133,893 discloses coating pigments (which have been treated with a surface-active agent) with a polyacrylonitrile which was polymerized in the presence of the pigment. The pigments thus coated can be incorporated into fibers. For use in the coloring of substrates, however, haptic properties such as hand for example are not up to present day standards in many cases.

U.S. Pat. No. 4,608,401 discloses a method of encapsulating pigments for latex paints which comprises the steps of dispersing pigment particles in water using water-insoluble monomers and a detergent under zero-shear conditions and then subjecting the dispersion to the conditions of an emulsion polymerization. For use in the coloring of substrates, however, haptic properties such as hand for example are not up to present day standards in many cases.

U.S. Pat. No. 4,680,200 discloses a method of encapsulating nonpretreated pigments which comprises dispersing pigment particles in water using styrene and the Polywet KX-3 oligomer from Uniroyal and then subjecting the dispersion to the conditions of an emulsion polymerization.

U.S. Pat. No. 3,544,500 discloses a process of preparing pigments coated with specific polymers, said pigments being prepared by adsorbing water-soluble polymers physically on the polymer and then introducing a non-solvated anchor component. However, the use of water-soluble polymers for coating pigments for inks for the ink jet process is not of advantage, since the coating will become detached again on prolonged storage of the ink. Moreover, especially printed textiles are not sufficiently wet- and perspirationfast, nor is washfastness sufficiently good in many cases.

U.S. Pat. No. 4,608,401 describes a method of preparing coated pigments which is restricted to pigments bearing no ionic charges. The pigments mentioned are coated by suspension polymerization of a water-insoluble monomer. For use in the coloring of substrates, however, haptic properties such as hand for example are not up to present day standards in many cases.

EP-A 1 245 653 describes a process for preparing inks for the ink jet process which comprises mixing pigment particles with water-soluble monomers such as acrylic acid for example and optionally further comonomers and then subjecting the mixture to an emulsion polymerization. The waterfastness and especially the washfastness of substrates printed with the disclosed inks is in many cases inadequate.

The present invention further relates to the use of the pigments in particulate form which have been treated according to the present invention for producing colorant preparations, in particular for preparations for coloration of leather. The present invention further relates to a process for coloration of leather and to colored leather produced using the pigments in particulate form which have been treated according to the present invention. The present invention finally relates to footwear produced from leather colored according to the present invention.

Leather is typically finished by coating it in a plurality of plies. A three-ply coating is particularly common, the first coating being a so-called bottoming, which comprises for example pigments, binders and auxiliaries to achieve adhesion for the entire finish. The second coating used is a so-called pigment coat, which is usually made somewhat harder than the first layer, the third layer applied is a topcoat, which decisively influences the ultimate appearance and the hand. Methods used to apply all layers include more typical coating techniques such as for example spraying, brushing, casting, printing and laminating.

It is an object of the present invention to provide a process for treating pigments in particulate form which avoids prior art disadvantages. It is a further object of the present invention to provide treated pigments in particulate form. It is yet a further object of the present invention to provide uses for treated pigments in particulate form.

We have found that the first object is achieved by the process defined at the beginning.

The inventive process has pigments in particulate form as its starting point. Pigments for the purposes of the present invention are virtually insoluble, finely dispersed, organic or inorganic colorants as per the definition in German standard specification DIN 55944. The inventive process preferably has organic pigments as its starting point.

Representative examples of organic pigments are

| | |
|---|---|
| monoazo | C.I. Pigment Brown 25; C.I. Pigment Orange 5, |
| pigments: | 13, 36 and 67; C.I. Pigment Red 1, 2, 3, 5, 8, |
| | 9, 12, 17, 22, 23, 31, 48:1, 48:2, 48:3, 48:4, 49, |
| | 49:1, 52:1, 52:2, 53, 53:1, 53:3, 57:1, 63, 112, |
| | 146, 170, 184, 210, 245 and 251; C.I. Pigment |
| | Yellow 1, 3, 73, 74, 65, 97, 151 and 183; |
| disazo | C.I. Pigment Orange 16, 34 and 44; C.I. |
| pigments: | Pigment Red 144, 166, 214 and 242; C.I. |
| | Pigment Yellow 12, 13, 14, 16, 17, 81, 83, 106, |
| | 113, 126, 127, 155, 174, 176 and 188; |
| anthanthrone | C.I. Pigment Red 168 (C.I. Vat Orange 3); |
| pigments: | |
| anthraquinone | C.I. Pigment Yellow 147 and 177; C.I. Pigment |
| pigments: | Violet 31; |
| anthraquinone | C.I. Pigment Yellow 147 and 177; C.I. Pigment |
| pigments: | Violet 31; |
| anthrapyrimidine | C.I. Pigment Yellow 108 (C.I. Vat Yellow 20); |
| pigments: | |
| quinacridone | C.I. Pigment Red 122, 202 and 206; C.I. |
| pigments: | Pigment Violet 19; |
| quinophthalone | C.I. Pigment Yellow 138; |
| pigments: | |
| dioxazine | C.I. Pigment Violet 23 and 37; |
| pigments: | |
| flavanthrone | C.I. Pigment Yellow 24 (C.I. Vat Yellow 1); |
| pigments: | |
| indanthrone | C.I. Pigment Blue 60 (C.I. Vat Blue 4) and 64 |
| pigments: | (C.I. Vat Blue 6); |
| isoindoline | C.I. Pigment Orange 69; C.I. Pigment Red |
| pigments: | 260; C.I. Pigment Yellow 139 and 185; |
| isoindolinone | C.I. Pigment Orange 61; C.I. Pigment Red 257 |
| pigments: | and 260; C.I. Pigment Yellow 109, 110, 173 |
| | and 185; |
| isoviolanthrone | C.I. Pigment Violet 31 (C.I. Vat Violet 1); |
| pigments: | |
| metal complex | C.I. Pigment Yellow 117, 150 and 153; C.I. |
| pigments: | Pigment Green 8; |
| perinone | C.I. Pigment Orange 43 (C.I. Vat Orange 7); |
| pigments: | C.I. Pigment Red 194 (C.I. Vat Red 15); |
| perylene | C.I. Pigment Black 31 and 32; C.I. Pigment |
| pigments: | Red 123, 149, 178, 179 (C.I. Vat Red 23), 190 |
| | (C.I. Vat Red 29) and 224; C.I. Pigment Violet |
| | 29; |
| phthalocyanine | C.I. Pigment Blue 15, 15:1, 15:2, 15:3, 15:4, |
| pigments: | 15:6 and 16; C.I. Pigment Green 7 and 36; |
| pyranthrone | C.I. Pigment Orange 51; C.I. Pigment Red 216 |
| pigments: | (C.I. Vat Orange 4); |
| thioindigo | C.I. Pigment Red 88 and 181 (C.I. Vat Red 1); |
| pigments: | C.I. Pigment Violet 38 (C.I. Vat Violet 3); |
| triarylcarbonium | C.I. Pigment Blue 1, 61 and 62; C.I. Pigment |
| pigments: | Green 1; C.I. Pigment Red 81, 81:1 and 169; |
| | C.I. Pigment Violet 1, 2, 3 and 27; C.I. Pigment |
| | Black 1 (aniline black); |
| | C.I. Pigment Yellow 101 (aldazine yellow); |
| | C.I. Pigment Brown 22. |

Specific examples of particularly preferred pigments are: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

The process of the present invention can also have mixtures of two or more different pigments as its starting point, in which case it is preferable that at least one pigment be organic. The starting pigments are in particulate form, i.e., in the form of particles. The starting pigments are customarily crude pigments, i.e., untreated as-synthesized pigments. The particles may be regular or irregular in shape in that, for example, the particles may have a spherical or substantially spherical shape or a needle (acicular) shape.

In one embodiment of the present invention, the particles are present in spherical or substantially spherical shape, i.e., the ratio of the longest diameter to the smallest diameter is in the range from 1.0 to 2.0, preferably up to 1.5.

The pigment or pigments in particulate form is or are mixed with at least one nonionic surface-active substance in step a).

Representative examples of suitable nonionic surface-active substances are ethoxylated mono-, di- and trialkylphenols (degree of ethoxylation: 3-50, alkyl radical: C₃-C₁₂) and also ethoxylated fatty alcohols (degree of ethoxylation: 3-80; alkyl radical: C₈-C₃₆). Examples thereof are the Lutensol® brands from BASF AG or the Triton® brands from Union Carbide. Particular preference is given to ethoxylated linear fatty alcohols of the general formula III
n-CₓH₂ₓ₊₁—O(CH₂CH₂O)_{y}—H, III
where each x is an integer from 10 to 24 and preferably from 12 to 20. y is preferably an integer from 5 to 50 and more preferably from 8 to 40.

Ethoxylated linear fatty alcohols of the general formula III are typically present as a mixture of various ethoxylated fatty alcohols having different degrees of ethoxylation. y represents the number-average mean in the context of the present invention.

The mixing of pigment in particulate form and at least one nonionic surface-active substance is effected in apparatus which is suitable for mixing, preferably in mills such as for example ball mills or stirred media mills. A Drais Superflow DCP SF 12 ball mill is particularly suitable.

An example of a suitable mixing time is in the range from ½ hour to 48 hours, but longer times are conceivable. The mixing time is preferably in the range from 5 to 24 hours.

Mixing pressure and temperature conditions are generally not critical in that, for example, atmospheric pressure has been found to be suitable. As for temperatures, temperatures in the range from 10° C. to 100° C. for example have been found to be suitable.

The mixing ratio of pigment to nonionic surface-active substance can be chosen within wide limits and may be for example in the range from 10:1 to 2:1.

Water may be added while step a) is carried out. Similarly, customary nonionic grinding assistants may be added.

The pigment median diameter after step a) is typically in the range from 20 nm to 1.5 μm, preferably in the range from 50 to 200 nm and more preferably 100 nm.

Step b) consists in dispersing the mixture of pigment in particulate form and nonionic surface-active substance that is obtainable according to step a), in an aqueous medium. Any desired dispersing apparatus may be used, for example stirred tanks or stirred flasks.

An aqueous medium for the purposes of the present invention is a liquid medium which includes water as an important component, for example at not less than 40% by weight and preferably at not less than 55% by weight.

The step b) weight ratio of the mixture of pigment particles and nonionic surface-active substance to the aqueous medium is generally in the range from 1:1.5 to 1:15, and preferably in the range from 1:2.5 to 1:9.

Step b) pressure and temperature conditions are generally not critical in that, for example, temperatures in the range from 5 to 100° C. are suitable, preferably from 20 to 85° C., and pressures in the range from atmospheric pressure to 10 bar.

The dispersing of step b) results in a dispersion.

Step c) consists in polymerizing at least one first monomer or copolymerizing a first mixture of comonomer in the presence of a dispersion obtainable according to b) to form water-insoluble polymer or copolymer on the surface of the pigment particles. Step c) is carried out by adding at least one monomer or at least one mixture of comonomers to a dispersion obtainable according to b). The addition can be effected for example in one portion, in multiple portions or else continuously. To copolymerize at least different monomers with each or one another, at first one comonomer may be added and thereafter the second and any further comonomers. In another embodiment, all the comonomers are added in one portion.

Monomer and comonomers may be added neat or in aqueous dispersion.

The monomers and comonomers chosen for step c) are such monomers and comonomers as are sparingly soluble in water. “Sparingly water-soluble monomers and comonomers” is to be understood as meaning such monomers and comonomers as have a solubility in water of 1×10⁻¹ mol/l or less at 50° C.

Preferred examples of monomers and comonomers in step c) are vinyl-aromatic compounds and sparingly water-soluble α,β-unsaturated carboxylic acid derivatives.

As vinyl-aromatic compound there is preferably chosen at least one compound of the general formula IV 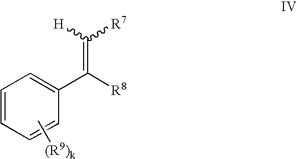
where R⁷ and R⁸ are each independently hydrogen, methyl or ethyl, R⁹ is methyl or ethyl and k is an integer from 0 to 2; most preferably, R⁷ and R⁸ are each hydrogen and most preferably k=0.

As sparingly water-soluble α,β-unsaturated carboxylic acid derivative there is preferably chosen a compound of the general formula I 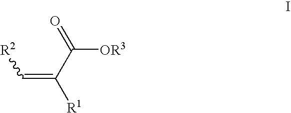
where
R¹ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or hydrogen,
   most preferably hydrogen and methyl;
R² is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen.
R³ is selected from branched or unbranched C₄-C₁₀-alkyl, such as n-butyl, iso-butyl, sec-butyl, tert-butyl, n-pentyl, iso-pentyl, sec-pentyl, neo-pentyl, 1,2-di-methylpropyl, iso-amyl, n-hexyl, iso-hexyl, sec-hexyl, n-heptyl, n-octyl, 2-ethyl-hexyl, n-nonyl, n-decyl; most particularly n-butyl and 2-ethylhexyl.

In one embodiment of the present invention, the ratio of pigment to amount of monomer or comonomers in step c) is in the range from 3:1 to 1:2 and preferably in the range from 2:1 to 1:1.5.

Step c) may be carried out using mixtures of the aforementioned monomers. For example, mixtures of styrene and n-butyl acrylate are very useful, their mixing ratio being freely choosable.

Polymerizing is preferably carried out under the conditions of an emulsion polymerization. Most preferably, starved conditions are employed in that little or preferably no wetting agent is added. There are thus no detectable fractions obtained of stabilized droplets of first monomer or of first mixture of comonomers, and the wetting agent fraction serves to wet the pigment surface and to transport first monomer, or first mixture of comonomers, through the continuous aqueous phase. Useful wetting agents include for example organic sulfur compounds, for example alkyl sulfates, alkyl sulfonates, alkylaryl sulfonates, alkyl ether sulfates, alkylaryl ether sulfates, sulfosuccinates such as sulfosuccinic monoesters and sulfosuccinic diesters; also organic phosphorus compounds such as alkylether phosphates for example.

The polymerization will typically be carried out using at least one initiator. At least one initiator can be a peroxide. Examples of suitable peroxides are alkali metal peroxodisulfates, for example sodium peroxodisulfate, ammonium peroxodisulfate, hydrogen peroxide, organic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate. It is also possible to use azo compounds such as for example azobisisobutyronitrile, azobis(2-amidopropane) dihydrochloride and 2,2′-azobis(2-methylbutyronitrile).

Redox initiators are likewise suitable, composed for example of peroxides and an oxidizable sulfur compound. Very particular preference is given to systems formed from acetone bisulfite and organic peroxide such as tert-C₄H₉—OOH, Na₂S₂O₅ (sodium disulfite) and organic peroxide such as tert-C₄H₉—OOH or of a combination of alkali metal salt of HO—CH₂SO₂H and organic peroxide such as tert-C₄H₉—OOH. Similarly, systems such as for example ascorbic acid/H₂O₂ are particularly preferred.

The polymerization temperature may be chosen in the range from 20 to 100° C. and preferably in the range from 50 to 85° C. The temperature chosen is dependent on the decomposition characteristics of the initiator used.

Pressure conditions are generally not critical, pressures in the range from atmospheric pressure to 10 bar being suitable for example.

The time for step c) is for example in the range from 1 to 30 minutes, preferably in the range from 2 to 10 minutes and more preferably in the range from 3 to 5 minutes.

It will be appreciated that further substances can be added to the reaction mixture that are customary in emulsion polymerization, for example glycols, polyethylene glycols, protective colloids, buffers/pH regulators, molecular weight regulators and chain transfer inhibitors.

Step c) provides polymer- or copolymer-coated pigment in particulate form, the pigment being obtained in the form of isolated particles. No measurable or only extremely small fractions of agglomerates are observed, for example less than 2% by weight and preferably less than 0.2% by weight.

The polymer or copolymer formed in step c) at the surface of the pigment in particulate form is water-insoluble.

A further step may be carried out whereby the dispersed polymer- or copolymer-coated pigment particles obtainable according to c) are isolated by purifying operations, for example filtering, decanting, washing, and redispersed for practicing step d) of the process of the present invention. Preferably, however, the dispersed polymer- or copolymer-coated pigment particles obtainable according to c) are further processed in situ.

Step d) of the process according to the present invention consists in adding at least one second monomer, or a second mixture of comonomers, to the dispersion from step c) or to the worked-up and redispersed coated pigments and polymerizing or copolymerizing.

The reference in the context of the present invention to a second mixture of comonomers in step d) also applies when one monomer was used in step c) and a mixture of two comonomers is added in step d). Similarly, the reference in the context of the present invention to a second monomer in step d) is to be understood as also comprehending the case when a mixture of comonomers was used in step c) and one monomer is added in step d).

When it is desired to add a second mixture of comonomers, at least one comonomer other than the monomer or the comonomers of step c) is added.

One embodiment of the present invention utilizes a vinyl-aromatic monomer in step c) and at least one monomer or comonomer capable of swelling polymer or copolymer of step c) in step d). Swelling is to be understood as meaning that, under normal conditions, at least 5% by weight of monomer or comonomer can be physically incorporated in the polymer or copolymer of step c).

It is very particularly preferred to add at least one monomer or comonomer of the general formula II 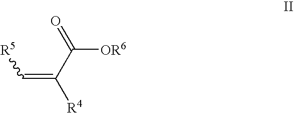
where
R⁴ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or hydrogen;
most preferably hydrogen and methyl;
R⁵ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen,
R⁶ is selected from branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl.

To add a mixture of comonomers in step d), it will be sufficient for at least one comonomer to differ from the monomer or comonomer of step c). For instance, styrene may be used in step c) and a mixture of methyl acrylate and styrene in step d).

In one embodiment of the present invention, the weight ratio of second monomer or second mixture of comonomers from step d) to pigment from step a) is in the range from 0.7:1 to 10:1, preferably in the range from 1.5:1 to 5:1 and more preferably in the range from 2:1 to 4:1.

Overall, the amount of monomer or comonomer for steps c) and d) of the process of the present invention is chosen so that the ratio of polymer or copolymer to pigment is in the range from 1:1 to 5:1 and preferably in the range from 2:1 to 4:1.

The polymerizing or copolymerizing of step d) is preferably carried out under the conditions of an emulsion polymerization. Typically, at least one initiator is used, and the initiator or initiators can be chosen from those mentioned above.

It is possible to use at least one emulsifier, which may be anionic, cationic or nonionic.

Customary nonionic emulsifiers are for example ethoxylated mono-, di- and tri-alkylphenois (degree of ethoxylation: 3-50, alkyl radical: C₄-C₁₂) and also ethoxylated fatty alcohols (degree of ethoxylation: 3-80; alkyl radical: C₈-C₃₆). Examples are the Lutensol® brands from BASF Aktiengesellschaft and the Triton® brands from Union Carbide.

Customary anionic emulsifiers are for example alkali metal and ammonium salts of alkyl sulfates (alkyl radical: C₈ to C₁₂), of sulfuric acid monoesters formed from ethoxylated alkanols (degree of ethoxylation: 4-30, alkyl radical: C₁₂-C₁₈) and from ethoxylated alkylphenols (degree of ethoxylation: 3-50, alkyl radical: C₄-C₁₂), of alkylsulfonic acids (alkyl radical: C₁₂-C₁₈) and of alkylarylsulfonic acids (alkyl radical: C₉-C₁₈) and of sulfosuccinates such as sulfosuccinic mono- and diesters for example.

Suitable cationic emulsifiers are in general C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morphplinium salts, thiazolinium salts and also salts of amine oxides, quinolinium salts, isoquinolinium salts, tropylium salts, sulfonium salts and phosphonium salts. By way of example there may be mentioned dodecylammonium acetate or the corresponding hydrochloride, the chlorides or acetates of the various 2-(N,N,N-tri-methylammonium)ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryldimethyl)ethylenediamine dibromide. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

In one embodiment of the present invention, the amount of emulsifier is chosen so that the mass ratio between the second monomer or the second mixture of comonomers on the one hand and the emulsifier on the other is more than 1, preferably more than 10 and more preferably more than 20.

The order in which the reactants of step d) are added is in itself not critical.

In one embodiment of the present invention, the initiator is added when an emulsion having a milky appearance has been produced by stirring for example.

The polymerization temperature may be chosen in the range from 20 to 100° C. and preferably in the range from 50 to 85° C. The temperature chosen is dependent on the decomposition characteristics of the initiator used.

Pressure conditions are generally not critical, pressures in the range from atmospheric pressure to 10 bar being suitable for example.

As duration for the polymerization or copolymerization in step d) it is possible to choose a time in the range from 30 minutes to 12 hours, preference being given to the range from 2 to 3 hours.

In one embodiment of the present invention, step d) utilizes as a comonomer up to 10% by weight and preferably from 2 to 5% by weight based on monomers or comonomers of step d) of at least one compound of the general formula V a to V b 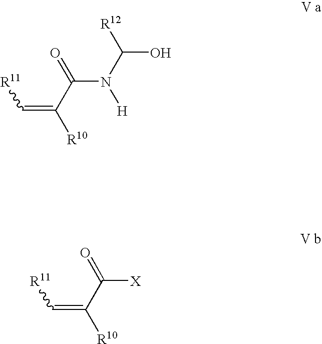
where
R¹⁰ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or hydrogen;
most preferably hydrogen and methyl;
R¹¹ is selected from
   branched or unbranched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen.
R¹² is selected from branched or unbranched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; particularly preferably C₁-C₄-alkyl such as methyl, ethyl, n-propyl, iso-propyl, n-butyl, iso-butyl, sec-butyl and tert-butyl,
   or most preferably hydrogen.
X is selected from
   hydrogen,
   glycidyl 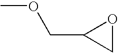
   groups having tertiary amino groups, for example NH(CH₂)_{b}—N(CH₃)₂, where b is an integer from 2 to 6,
   enolizable groups having 1 to 20 carbon atoms, for example acetoacetyl 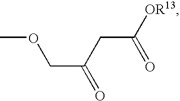
      where
R¹³ is selected from unbranched or branched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; particularly preferably C₁-C₄-alkyl such as methyl, ethyl, n-propyl, iso-propyl, n-butyl, iso-butyl, sec-butyl and tert-butyl.

Most preferably, in the formula V a or V b, R¹⁰ is selected from hydrogen and methyl and R¹¹ and R¹² are each hydrogen.

In one further embodiment of the present invention, step d) may be carried out using as comonomers: from 1% to 5% by weight each of (meth)acrylonitrile, (meth)acrylamide, ureido (meth)acrylate, 2-hydroxyethyl (meth)acrylate, 3-hydroxypropyl (meth)acrylate, acrylamidepropanesulfonic acid, branched or unbranched, sodium salt of vinylsulfonic acid.

In one embodiment of the present invention, the second mixture of comonomers is chosen so that it comprises from 0.1 to 3% by weight, based on the amount of pigment in particulate form, of one or more unsaturated carboxylic acids of the formula VI 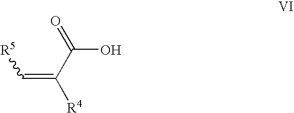
where the symbols are each as defined above.

In one embodiment of the present invention, the second monomer or mixture of comonomers is chosen such that a polymer or copolymer having a glass transition temperature T_{g} of about 0° C. is prepared in step d).

In another embodiment of the present invention, the second monomer or mixture of comonomers is chosen such that a polymer or copolymer having a glass transition temperature T_{g} of 30° C. or higher is prepared in step d).

The two aforementioned embodiments are preferred whenever pigment in particulate form which has been treated according to the present invention is to be used for coloration of textile.

In another embodiment of the present invention, the second monomer or mixture of comonomers is chosen such that a polymer or copolymer having a glass transition temperature T_{g} of below 20° C. is prepared in step d).

The aforementioned embodiment is preferred whenever pigment in particulate form which has been treated according to the present invention is to be used for coloration of leather.

The present invention further provides pigments in particulate form which have been treated by the process of the present invention. They are customarily obtained in the form of aqueous dispersions, which likewise form part of the subject matter of the present invention, and are easily separated off by measures known to one skilled in the art.

Inventive aqueous dispersions of inventively treated pigments in particulate form may have a solids content in the range from 10% to 50% by weight and preferably in the range from 30% to 40% by weight.

Inventively treated pigments are coated with at least one layer of polymers or copolymers derived respectively from step c) monomers and comonomers and step d) monomers and comonomers. The majority of inventively treated pigments are coated with two polymer or copolymer layers, which may be interpenetrating and need not be strictly divorced from each other. The particles thus characterized will hereinafter also be referred to as pigment-containing polymer particles.

The inventively treated pigments in particulate form may be present mixed with polymer or copolymer derived from step d) monomers or mixtures of comonomers.

In a preferred embodiment of the present invention, the inventively treated pigments are present mixed with polymer or copolymer derived from step d) monomers or mixtures of comonomers. The polymer or copolymer derived respectively from step d) monomers and mixtures of comonomers is preferably obtained in the form of spherical particles. The particles thus characterized are hereinafter also referred to as pigment-free polymer particles.

In a preferred embodiment, the weight ratio of pigment-containing polymer particles to pigment-free polymer particles is in the range from 10:0.1 to 10:3 and preferably in the range from 10:0.5 to 10:2.

In a preferred embodiment, the average radii r of pigment-free polymer particles are smaller than the average radii r of pigment-containing polymer particles, each based on the number average. The radii ratio

$$\frac{r ( pigment \text{-} containing polymer particles )}{r ( pigment \text{-} free polymer particles )}$$

may be for example in the range from 1.2 to 10, preferably in the range from 2 to 5.

The present invention further provides for the use of inventively treated pigments in particulate form as or for producing colorant preparations. The present invention further provides a process for producing colorant preparations using inventively treated pigments in particulate form. The present invention further provides colorant preparations produced using inventively treated pigments in particulate form. Inventive colorant preparations may be produced using the inventive aqueous dispersions as such and also the inventively treated pigments separated from the inventive dispersions.

The present invention further provides for the use of inventively treated pigments in particulate form as or for producing inks for the ink jet process. The present invention further provides a process for producing inks for the ink jet process using inventively treated pigments in particulate form. The present invention further provides inks for the ink jet process produced using inventively treated pigments in particulate form. Inventive inks for the ink jet process may be produced using the inventive aqueous dispersions as such and also the inventively treated pigments separated from the inventive dispersions.

Inventive colorant preparations and especially inventive inks for the ink jet process are particularly easy to produce by inventively prepared dispersions being diluted with, for example, water and optionally admixed with additives.

In a preferred embodiment of the present invention, an inventive ink for the ink jet process comprises from 1 to 50 g/100 ml, and preferably from 1.5 to 15 g/100 ml of inventively treated pigment in particulate form.

Additives for inclusion in inventive colorant preparations and especially inventive inks for the ink jet process include organic solvents. Low molecular weight polytetrahydrofuran is a preferred additive, it may be used alone or preferably mixed with one or more high-boiling water-soluble or water-miscible organic solvents.

The preferably used low molecular weight polytetrahydrofuran customarily has an average molecular weight M_{w} from 150 to 500 g/mol, preferably from 200 to 300 g/mol and more preferably of about 250 g/mol (as corresponds to a molecular weight distribution).

Polytetrahydrofuran is preparable in a known manner via cationic polymerization of tetrahydrofuran. The products are linear polytetramethylene glycols.

When polytetrahydrofuran mixed with further organic solvents is used as an additive, the solvents used for this purpose are generally high boiling (i.e., have a boiling point >100° C. at atmospheric pressure) and hence water-retaining organic solvents which are soluble in or miscible with water.

Useful solvents include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, glycerol, erythritol, pentaerythritol, pentitols such as arabitol, adonitol and xylitol and hexitols such as sorbitol, mannitol and dulcitol.

Useful solvents further include polyethylene glycols and polypropylene glycols (which is also to be understood as meaning the lower polymers (di-, tri- and tetramers)) and their mono (especially C₁-C₆, in particular C₁-C₄) alkyl ethers. Preference is given to polyethylene and polypropylene glycols having average molecular weights of from 100 to 1 500 g/mol, in particular from 200 to 800 g/mol, mainly from 300 to 500 g/mol. Examples are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ether.

Useful solvents further include pyrrolidone and N-alkylpyrrolidones whose alkyl chain preferably comprises from 1 to 4, especially 1 or 2, carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (M_{w} from 300 to 500 g/mol), diethylene glycol monobutyl ether, triethylene glycol monobutyl ether, pyrrolidone, N-methylpyrrolidone and N-(2-hydroxyethyl)pyrrolidone.

Polytetrahydrofuran may also be mixed with one or more (e.g., two, three or four) of the abovementioned solvents.

In one embodiment of the present invention, the inventive colorant preparations and especially the inventive inks for the ink jet process may comprise from 0.1% to 80% by weight, preferably from 5% to 60% by weight, more preferably from 10% to 50% by weight and most preferably from 10% to 30% by weight of nonaqueous solvents.

Nonaqueous solvent additives, including especially the particularly preferred solvent combinations mentioned, may advantageously be augmented with urea (generally from 0.5% to 3% by weight, based on the weight of the colorant preparation) to further enhance the water-retaining effect of the solvent mixture.

The inventive colorant preparations and especially the inventive inks for the ink jet process may comprise further assistants of the type which are customary especially for aqueous ink jet inks and in the printing and coatings industry. Examples of such assistants are preservatives such as for example 1,2-benzisothiazolin-3-one (commercially available as Proxel brands from Avecia Lim.) and its alkali metal salts, glutaraldehyde and/or tetramethylolacetylenediurea, Protectols®, antioxidants, degasers/defoamers such as for example acetylenediols and ethoxylated acetylenediols, which customarily comprise from 20 to 40 mol of ethylene oxide per mole of acetylenediol and also may have a dispersing effect, agents for regulating the viscosity, flow assistants, wetting agents (for example wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyethersiloxane copolymers, especially alkoxylated 2-(3-hydroxypropyl)heptamethyltrisiloxanes, which generally have a block of 7 to 20 and preferably 7 to 12 ethylene oxide units and a block of 2 to 20 and preferably 2 to 10 propylene oxide units and may be comprised in the colorant preparations in amounts from 0.05% to 1% by weight), antisettling agents, luster improvers, lubricants, adhesion promoters, antiskinning agents, delusterants, emulsifiers, stabilizers, hydrophobicizers, light control additives, hand improvers, antistats, bases such as for example triethanolamine or acids, specifically carboxylic acids such as for example lactic acid or citric acid for regulating the pH. When these agents are part of inventive colorant preparations and especially inventive inks for the ink jet process, their total amount will generally be 2% by weight and especially 1% by weight, based on the weight of the inventive colorant preparations and especially of the inventive inks for the ink jet process.

In one embodiment of the present invention, the inventive colorant preparations and especially the inventive inks for the ink jet process have a dynamic viscosity in the range from 2 to 80 mPa·s and preferably in the range from 3 to 20 mPa·s, measured at 20° C.

The surface tension of inventive colorant preparations and especially of inventive inks for the ink jet process is generally in the range from 24 to 70 mN/m and especially in the range from 25 to 60 mN/m, measured at 20° C.

The pH of inventive colorant preparations and especially of inventive inks for the ink jet process is generally in the range from 5 to 10 and preferably in the range from 6 to 9.

A further aspect of the present invention is a process for printing sheetlike or three-dimensional substrates by the ink jet process using the inventive colorant preparations. To this end, the inventive colorant preparations or the inventive ink jet inks are printed onto the substrate and optionally the print obtained is subsequently fixed.

In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble jet process) to exert pressure on the ink system and so eject an ink droplet. These techniques are described in Text. Chem. Color 19 (1987), No. 8, 23-29, and 21 (1989), No. 6, 27-32.

The inventive inks are particularly suitable for the bubble jet process and for the process employing a piezoelectric crystal. Useful substrate materials include:
coated or uncoated cellulosics such as paper, paperboard, cardboard, wood and woodbase,
coated or uncoated metallic materials such as foils, sheets or workpieces composed of aluminum, iron, copper, silver, gold, zinc or alloys thereof,
coated or uncoated silicatic materials such as glass, porcelain and ceramic,
polymeric materials of any kind such as polystyrene, polyamides, polyesters, polyethylene, polypropylene; melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers such as gelatin,
leather—both natural and artificial—in the form of smooth leather, nappa leather or suede leather,
comestibles and cosmetics, and in particular
textile substrates such as fibers, yarns, threads, knits, wovens, nonwovens and garments composed of polyester, modified polyester, polyester blend fabrics, cellulosics such as cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabrics.

The inventive colorant preparations and especially the inventive inks for the ink jet process exhibit overall advantageous application properties, especially good start-of-print behavior and good sustained use behavior (kogation) and also, especially when the particularly preferred solvent combination is used, good drying characteristics, and produce printed images of high quality, i.e., high brilliance and depth of shade and also high rubfastness, lighffastness, waterfastness and wetrubfastness. They are particularly suitable for printing coated and plain paper and also textile.

A further embodiment of the present invention provides substrates, especially textile substrates, which have been printed by one of the abovementioned inventive processes and are notable for particularly crisply printed images and drawings and also excellent hand.

In a further embodiment of the present invention, at least two, preferably at least three different inventive inks for the ink jet process may be combined to form sets, in which case various inventive inks each comprise different pigments each having a different color which have been treated by the process of the present invention.

The present invention further provides for the use of the present invention's treated pigments in particulate form for coloration of textile. The present invention further provides a process for coloration of textile using the present invention's treated pigments in particulate form, and the present invention further provides colored textile substrates obtainable by a present invention process for coloration of textile substrates.

Textile substrates for the purposes of the present invention are textile fibers, textile intermediate and end products and finished articles manufactured therefrom which, as well as textiles for the apparel industry, also include for example carpets and other home textiles and also textile structures for industrial purposes. These also include unshaped structures such as for example staples, linear structures such as twine, filaments, yarns, lines, strings, laces, braids, cordage and threads and also three-dimensional structures such as for example felts, wovens, formed-loop knits, nonwovens and waddings. The textiles may be of natural origin, for example cotton, wool or flax, or synthetic, for example polyamide, polyester, modified polyester, polyester blend fabric, polyamide blend fabric, polyacrylonitrile, triacetate, acetate, polycarbonate, polypropylene, polyvinyl chloride, polyester microfibers and glass fiber fabric.

The present invention provides that the above-described dispersions are used to produce a dyeing liquor for pigment dyeing or a print paste for pigment printing, specifically textile pigment printing. The present invention thus further provides a process for producing dyeing liquors for pigment dyeing and for producing print pastes for pigment printing and also the inventive dyeing liquors and print pastes, hereinafter also referred to as inventive production processes.

The inventive production process comprises mixing at least one inventive dispersion with assistants required for the dyeing or printing operation and adjusting the colorant content by diluting with water.

The water used for practicing the inventive production process need not be completely ion-free. It is customary to use incompletely deionized water or very soft water. If insufficiently soft water is available, it is customary to use complexing agents (water softeners) to control the hardness in the water. Useful water softeners for the pigment dyeing operation generally sequester Ca²⁺ and Mg²⁺ ions. Examples of particularly useful water softeners are nitrilotriacetic acid, ethylenediaminetetraacetic acid, diethylenetriaminepentaacetic acid, hydroxyethylethylenediaminetriacetic acid or methylglycinediacetic acid. The amount of water added to produce the dyeing liquor depends on the depth of shade to be produced on the textile on the one hand and on the amount of dyeing liquor padded onto the textile on the other.

Inventive dyeing liquors may further comprise additives. Preferred additives are organic solvents in concentrations from 0% to 10% by weight and preferably from 0.1% to 5% by weight. Useful solvents include for example polyethylene glycols and singly etherified alkylene glycol or singly etherified polyethylene glycols such as for example diethylene glycol mono-n-butyl ether.

Inventive dyeing liquors may further comprise a wetting agent additive, preferably a wetting agent of the low-foam type, since foaming due to the high turbulence of the dyeing operation impairs the quality of the dyeing by producing unlevelness. Wetting agents used include for example: ethoxylated and/or propoxylated products of fatty alcohols or propylene oxide-ethylene oxide block copolymers, ethoxylated or propoxylated fatty or oxo alcohols, also ethoxylates of oleic acid or alkylphenols, alkylphenol ether sulfates, alkylpolyglycosides, alkyl phosphonates, alkylphenyl phosphonates, alkyl phosphates and alkylphenyl phosphates.

Dry woven or loop-formingly knitted textiles as used in continuous pigment dyeing comprise a large amount of air. Dyeing here requires the use of deaerators. These are based for example on polyether siloxane copolymers or on phosphoric esters. They can be included in the inventive dyeing liquors in amounts from 0.01 to 2 g/l.

Inventive dyeing liquors may further include one or more hand improvers. These are generally polysiloxanes or waxes based on polyethylene or polyethylene glycol. Polysiloxanes have the advantage of permanence, whereas some waxes may be gradually washed off during use. In one embodiment of the present invention, however, no hand improver is included.

In one embodiment of the present invention, inventive dyeing liquors have a weakly acidic pH, preferably in the range from 4 to 6.5.

In one embodiment of the present invention, the dynamic viscosity of the inventive dyeing liquors is in the range below 100 mPa·s, measured at 20° C. The surface tensions of the inventive dyeing liquors are to be adjusted so as to enable fabric wetting. Surface tensions of less than 50 mN/m, as measured at 20° C., are widely used.

A further aspect of the present invention is a process for producing the inventive dyeing liquors. The inventive production process typically comprises mixing at least one inventively treated pigment in particulate form with one or more of the above-recited additives such as solvents, defoamers, hand improvers, emulsifiers and/or biocides and making up with water. The process customarily comprises the components being stirred in a mixing vessel, the size and shape of which are not critical. The stirring is preferably followed by a clarifying filtration.

A further aspect of the present invention is a process for dyeing textile substrates using the above-described inventive dyeing liquors. The process can be carried out in the usual machines. Preference is given to pad-mangles consisting essentially of two nip rolls through which the textile is led. The liquor sits above the rolls and wets the textile. The nip pressure causes the textile to be squeezed off and ensures a constant add-on.

In a further embodiment, the textile is led over a deflecting roller and through a trough holding the dyeing liquor. A pair of rolls which is disposed above the liquor is then used to squeeze off excess liquor to ensure a constant add-on.

The actual dyeing step is customarily followed by a thermal drying and fixation, preferably by drying at from 70 to 120° C. for from 30 seconds to 3 minutes and then fixing at from 150° C. to 200° C. for from 30 seconds to 5 minutes. Preference is given to a process for pigment dyeing by padding. The printed and dyed substrates are notable for particular brilliance of color coupled with outstanding hand. A further aspect of the present invention accordingly relates to substrates dyed by the above-described process using the inventive dyeing liquors.

A further aspect of the present invention is the use of inventively treated pigments in particulate form for textile printing. The invention provides that at least one inventively treated pigment in particulate form be for this purpose incorporated in a print paste. Advantageously, the inventive print paste for textile printing is produced from at least one inventively treated pigment in particulate form by mixing with customary printing process assistants and then adjusting the colorant content by diluting with water.

Commonly used assistants are known from Ullmann, Handbuch der technischen Chemie und Verfahrenstechnik, cf. for example Ullmann's Encyclopedia of Industrial Chemistry, 5th edition, Textile Auxiliaries, vol. A26, p. 286 ff. and 296 ff., Verlag Chemie, Weinheim, Deerfield/Fla., Basle; 1996. Examples of commonly used assistants are thickeners, fixers, hand improvers and emulsifiers.

Natural and synthetic thickeners can be used. Preference is given to the use of synthetic thickeners, for example generally liquid solutions of synthetic polymers in for example white oil or as aqueous solutions. The polymers comprise acid groups which are wholly or partly neutralized with ammonia. The fixing operation releases ammonia, whereby the pH is lowered and the actual fixing begins. The pH lowering needed for fixing may alternatively be effected by addition of nonvolatile acids such as for example citric acid, succinic acid, glutaric acid or malic acid.

The inventive ready-produced paste may comprise from 30% to 70% by weight of white oil. Aqueous thickeners typically comprise up to 25% by weight of polymer. When aqueous formulations of thickeners are to be used, it is customary to add aqueous ammonia. Similarly, the use of granular, solid formulations of a thickener is conceivable in order that pigment prints may be produced with zero emissions.

Inventive print pastes may further comprise hand improvers, which are typically selected from silicones, especially polydimethylsiloxanes, and fatty acid esters. Examples of commercially available hand improvers useful for inclusion in the inventive print pastes are Acramin® Weichmacher SI (Bayer AG), Luprimol SIG® and Luprimol CW® (BASF Aktiengesellschaft).

Inventive print pastes may further include one or more emulsifiers, especially when the pastes comprise thickeners containing white oil and are obtained as an oil-in-water emulsion. Examples of suitable emulsifiers include aryl- or alkyl-substituted polyglycol ethers. Commercially available examples of suitable emulsifiers are Emulgator W® (Bayer), Luprintol PE New® and Luprintol MP® (BASF Aktiengesellschaft), and Solegal W® (Hoechst AG).

Further possible ingredients include Brønsted acids, the use of which is preferable in the case of nonaqueous-based pastes in particular. Preference is given to ammonium salts of inorganic acids, for example diammonium hydrogenphosphate.

Pigment printing using at least one inventively treated pigment in particulate form can be carried out by various processes known per se. It is customary to use a screen through which the print paste is forced with a squeegee. This process belongs to the screen printing processes. The inventive pigment printing process utilizing the inventive print pastes provides printed substrates combining particularly high brilliance and depth of shade for the prints with excellent hand for the printed substrates. The present invention accordingly also provides substrates printed by the inventive process using the inventive print pastes.

A further embodiment of the present invention provides substrates, especially textile substrates, which have been colored by one of the abovementioned inventive processes and are notable for particularly crisply printed images or drawings and also excellent hand.

The present invention further provides for the use of the inventively treated pigments in particulate form for the coloring of leather. The present invention further provides a process for the coloring of leather using inventively treated pigments in particulate form, and the present invention further provides colored leather obtainable by an inventive process for coloration of leather.

Leather for the purposes of the present invention is to be understood as meaning pretanned, tanned and optionally retanned leather or correspondingly processed synthetic replacement material, which may have already been treated with at least one dye during at least one tanning step. Leather in the realm of the present invention has preferably already been hydrophobicized or fat liquored.

Pigment in particulate form that has been treated in accordance with the present invention is compatible with commercially available assistants for finishing leather to regulate hand, color, flow and viscosity. These are generally solutions (for example flow assistants, products based on glycol ethers, ethers, such as for example butylglycol, methoxypropanol, tributoxyethyl phosphate) or emulsions/dispersions with casein, waxes, silicones in the customary use quantities or concentrations (see F. Stather, Gerbereichemie u. Gerbereitechnologie, Akademie Verlag Berlin, 1967, pages 507-632).

In a specific embodiment of the present invention, the coloration process of the present invention is a process for top dyeing leather in the drum for the purpose of covering defects produced in a preceding dyeing of leather in the drum. A pigment in particulate form that has been treated in accordance with the present invention and which has a distinctly higher light fastness than customary tanning dyes (as determined for example according to DIN EN ISO 5 B02) is used to cover defects following a standard penetration dyeing with such dyes in the drum.

In another specific embodiment of the present invention, the leather coloration process of the present invention is a process for aniline type spray dyeing of leather, hereinafter also referred to as inventive spray dyeing. The natural surface and texture of leather preferably remains unchanged in an inventive spray dyeing.

An inventive spray dyeing is carried out by mixing pigment in particulate form that has been treated in accordance with the present invention with water and surfactant and spraying the thus obtained mixture with the aid of conventional means onto undyed leather.

As surfactant it is possible to use any commonly known ionic or nonionic surfactant, preference being given to nonionic surfactants. Examples of particularly preferred nonionic surfactants are alkoxylated saturated or unsaturated fatty alcohols or alkoxylated saturated or unsaturated fatty amines, i.e., alcohols or amines having more than 14 carbon atoms.

One embodiment of the present invention comprises preparing mixtures from
1% to 30% and preferably 5% to 25% by weight of pigment in particulate form that has been treated in accordance with the present invention,
0.1% to 10% and preferably 1 to 5% by weight of surfactant,
   the remainder being water, wherein weight percentages are each based on the mixture. One or more prepared mixtures are sprayed onto undyed leather.

In another embodiment of the present invention, the leather coloration process of the present invention is a process for finishing leather. The purpose of finishing/coating leather is to endow leather with a desired appearance, specific haptic properties and also service fastnesses, such as for example flex elasticity, amine resistance, wet and dry rub fastness and water fastness.

In one embodiment, the coloration process of the present invention proceeds from pretanned, tanned and optionally retanned leather which may have already been hydrophobicized and dyed in a conventional manner.

The initial step is to apply at least one bottoming dispersion or—when a two-layered bottoming build is desired, first an adhesion primer and then the bottoming dispersion—which may each comprise one or more pigments which have been treated in accordance with the present invention, in such an amount to the leather to be colored that about 10 to 100 g and preferably 20 to 50 g of solids are applied per m² of leather surface area. Application may be accomplished by conventional methods, for example by roll coating, spread coating, spraying, including airlessly, printing, laminating, plushing, brushing, casting or atomizing. The leather thus treated may subsequently be dried, for example at a temperature in the range from 30 to 80° C. and preferably from 60 to 80° C. The application of at least one bottoming dispersion may take place in one or more steps, which may be carried out identically or differently and may each be interrupted by an intervening drying operation at the abovementioned temperatures.

Bottoming dispersions used in accordance with the present invention, which are hereinafter also referred to as inventive bottoming dispersions, are typically aqueous. They may comprise further, nonaqueous solvents such as for example ethylene glycol, N-methylpyrrolidone, 3-methoxypropanol and propylene carbonate. In a preferred embodiment, inventive bottoming dispersions comprise the following constituents:
□|) at least one inventively treated pigment in particulate form, for example 1% to 10% by weight and preferably 1.5% to 5% by weight
□|) at least one wax, such as for example oxidized polyethylene wax, carnauba wax or montan wax for example preferably 1% to 15% by weight,
□|) at least one biocide, for example 1,2-benzisothiazolin-3-one (BIT) (commercially available as Proxel® brands from Avecia Lim.) and its alkali metal salts; other suitable biocides are 2-methyl-2H-isothiazole-3 (MIT) and 5-chloro-2-methyl-2H-isothiazol-3-one (CIT). In general, 10 to 150 ppm of biocide are sufficient.
□|) optionally at least one binder, for example acrylate-methacrylate copolymer binder. It may be preferable in this connection for the comonomer composition of the additional binder to approximately coincide with the copolymer as per d). Blending with a urethane binder may further be preferable for automotive leather.

Bottoming dispersions may further comprise at least one filling and antiadhesive agent. Suitable are for example aqueous formulations comprising fatty acid ester, albumin or proteins and inorganic filler which may be selected from silicates and clay minerals.

Inventive bottoming dispersions may have a solids content in the range from 10 to 80% by weight, preference being given to 20 to 50% by weight.

A pigment coat may subsequently be applied in a conventional manner. The pigment coat may consist of customary constituents.

In one embodiment of the present invention, the pigment coat comprises (each percentage being based on the total mass of the pigment coat):
□□) at least one pigment in particulate form, for example in the range from 0.05% to 5% by weight,
□□) optionally at least one further binder, preferably 20% to 70% by weight,
□□) optionally at least one thickener.

In a preferred embodiment of the present invention, the pigment coat comprises at least one binder whose hardness is higher than the hardness of the bottoming layer.

This may be followed by application of a top coating dispersion, at about 5 to 30 g/m² of leather surface area. The topcoat serves to protect the leather and shall ensure not only high flexibility but also good scratch resistance, oil resistance and water resistance. Depending on the desired article, the topcoat shall be lustrous or matte, i.e., matting agents or delusterants may also be added. Topcoats may comprise for example: formulations composed of at least one binder based on acrylate or polyurethane, a wetting agent, albumin, nitrocellulose emulsion, fillers based on organic or inorganic delusterants, silicone wax, fatty acid esters, fatty acids.

Top coating dispersions in accordance with the present invention, as well as pigment in particulate form which has been treated in accordance with the present invention, may comprise further, conventional binders, for example polyurethane dispersion prepared according to EP-A2 0 392 352.

Pigment coats and top coating dispersions may comprise one or more thickeners. Examples are crosslinkable copolymers based on acrylic acid and acrylamide and also thickeners based on polyurethane or polyvinylpyrrolidone or acrylate (co)polymers.

Application of the topcoat may be followed by drying under customary conditions, for example at temperatures in the range from 60 to 80° C., and subsequent hot pressing, for example at temperatures in the range from 90 to 160° C. It is also possible to hot press hydraulically, for example at reduced pressure and temperatures in the range from 70 to 100° C. Conventional apparatuses for ironing are contemplated or continuous pressing machines.

The leather finishing process of the present invention utilizes at least one formulation according to the present invention in at least one step—bottoming, pigment coating and top coating.

This may be followed by application of a topcoat in the form of a dispersion, also known as top coating dispersion in the realm of the present invention, in which case about 10 to 30 g of top coating dispersion are applied per m² of leather surface area.

In one embodiment of the present invention, the top coating dispersion comprises
□□) at least one pigment in particulate form that has been treated in accordance with the present invention, for example in the range from 0.05 to 5% by weight,
□□) optionally at least one wax, such as for example oxidized polyethylene wax or montan wax, suitable amounts being for example 20 to 70% by weight,
□□) optionally at least one biocide, for example 1,2-benzisothiazolin-3-one (BIT) (commercially available as Proxel® brands from Avecia Lim.) and its alkali metal salts; other suitable biocides are 2-methyl-2H-isothiazole-3 (MIT) and 5-chloro-2-methyl-2H-isothiazol-3-one (CIT). In general, 10 to 150 ppm of biocide are sufficient.
   □□) optionally at least one further binder, for example binders which contain urethane groups.

It will be appreciated that top coating dispersions may comprise further customary ingredients, for example shellac or one or more further pigments or nitrocellulose.

Top coating dispersions may comprise one or more thickeners. Examples are crosslinkable copolymers based on acrylic acid and acrylamide. Preferred examples are copolymers with 85 to 95% by weight of acrylic acid, 4 to 14% by weight of acrylamide and about 1% by weight of the (meth)acrylamide derivative of the formula VII 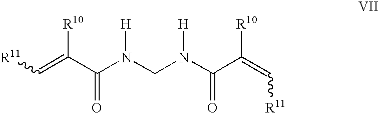
having molecular weights M_{w} in the range from 100 000 to 200 000 g/mol, in each of which the R¹⁰ and R¹¹ radicals may be the same or different and may be as defined above.

Application of the topcoat may be followed by drying under customary conditions, for example at temperatures in the range from 60 to 80° C., and subsequent hot pressing, for example at temperatures in the range from 90 to 160° C. It is also possible to hot press hydraulically, for example at reduced pressure and temperatures in the range from 70 to 100° C. Conventional apparatuses for ironing are contemplated or continuous pressing machines.

In the present invention, at least one coat selected from bottoming coat, pigment coat and topcoat comprises at least one pigment in particulate form that has been treated in accordance with the present invention. Preferably, however, at least two and more preferably at least three coats comprise at least one pigment in particulate form that has been treated in accordance with the present invention.

It is observed that pigments in particulate form which have been treated in accordance with the present invention have no measurable tendency to agglomerate or migrate on leather which has been colored in accordance with the present invention.

The present invention further provides colored leathers produced using at least one pigment in particulate form that has been treated in accordance with the present invention. Leathers in accordance with the present invention are notable for pleasant haptic properties coupled with particularly uniform coloration and low tendency for the pigment in particulate form to migrate and therefore are particularly useful for producing footwear. Leathers in accordance with the present invention are also particularly useful as furniture leather and in the automotive interior.

Working examples illustrate the invention.

General Preliminary Remarks

n-C₁₈H₃₇—(OCH₂CH₂)₂₅—OH is octadecanol ethoxylate prepared in accordance with the following prescription:

242 g of n-octadecanol and 0.1 mol of KOH chips were dewatered in an autoclave at 100° C. and a pressure of 1 mbar in the course of 2 hours, then depressurized with nitrogen and purged 3 times with nitrogen and then heated to 130° C. in an autoclave. On 130° C. having been reached, the continuous addition commenced of 1100 g of ethylene oxide and continued for 3 h 20 min, at a pressure of up to 6.1 bar. On completion of the addition the reaction was allowed to continue until constant pressure was reached. This was followed by cooling down to 100° C. and degassing in the autoclave at 1 mbar for 60 min before the reaction product was removed at 70° C. The yield was 1337 g.

The glass transition temperature was determined using a Mettler Toledo TA8200 series DSC822 differential scanning calorimeter with TSO 801 RO sample robot. The differential scanning calorimeter was equipped with an FSR5 temperature sensor. Working was in accordance with German standard specification DIN 53765.

### EXAMPLE I

Preparation of Inventively Treated Pigments in Particulate Form

I a) Mixing a Pigment in Particulate Form with a Nonionic Surface-Active Substance

1.1a) Blue Pigment

A Drais Superflow DCP SF 12 ball mill was used to grind together

| | |
|---|---|
| 1800 g | of Pigment Blue 15:3 |
| 450 g | of n-C₁₈H₃₇O(CH₂CH₂O)₂₅H |
| 24 g | of glutaraldehyde |
| 30 g | of tetramethylolacetylenediurea |
| 3696 g | of distilled water |

Grinding was continued until the pigment particles had an average diameter of 100 nm.

Mixture I.1a) of pigment in particulate form and nonionic surface-active substance was obtained.

I.2a) Mixing a Pigment with a Nonionic Surface-Active Substance

A Drais Superflow DCP SF 12 stirred ball mill was used to grind together:

| | |
|---|---|
| 1800 g | of Pigment Green 7 |
| 450 g | of n-C₁₈H₃₇O(CH₂CH₂O)₂₅H |
| 24 g | of glutaraldehyde |
| 30 g | of tetramethylolacetylenediurea |
| 3696 g | of distilled water |

Mixture I.2a) of pigment in particulate form and nonionic surface-active substance was obtained.

I b) Dispersing in Water

I.1 b) Dispersing the Mixture from I.1a) in Water

267 g of the mixture from I.1a) were dispersed with 270 g of distilled water by stirring in a 1 liter tank equipped with stirrer, nitrogen feed and three metering means. 7.1 g of 28% by weight sodium laurylsulfate as an aqueous solution and 60 g of styrene were added and a pH of 4.0 was set with formic acid.

This gave dispersion I.1b) of pigment in particulate form in an aqueous medium.

I.2b) Dispersion of the Mixture from I.2a in Water

Experiment I.1b) was repeated, but with mixture I.2a) instead of I.1a). This gave dispersion I.2b) of pigment in particulate form in an aqueous medium.

I.1c) Polymerization

Nitrogen was passed through the dispersion from step I.1b) for 1 hour. The dispersion was then heated to 85° C. Thereafter, 0.29 of tert-butyl hydroperoxide (70% by weight in water) and 0.2 g of HO—CH₂—SO₂Na were added.

The formation of a water-insoluble polymer on the pigment in particulate form was observed.

I.1d) Adding an Emulsion of Comonomers and Further Copolymerization

5 minutes after the addition of tert-butyl hydroperoxide and HO—CH₂—SO₂Na as per step I.1c) a mixture of the following composition was added over a period of 90 minutes:

100 g of completely ion-free water

13.4 g of 28% by weight aqueous solution of

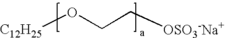

where a=3

6.6 g of 56.5% by weight aqueous solution of sodium di-2-ethylhexyl succinate sulfonate (sodium salt of di-2-ethylhexyl sulfosuccinate)

150 g of n-butyl acrylate

90 g of styrene

2.5 g of acrylic acid

7.5 g of compound V a.1 as a 15% by weight solution in water

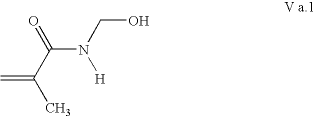

At the same time, the addition was commenced of a solution of 1.25 g of Na₂S₂O₈ in 60 g of water and continued over a period of 105 minutes. The temperature was maintained at 85° C. during the addition.

On completion of the addition, stirring was continued at 85° C. for 30 minutes and then, for deodorization, the concurrent addition was commenced of a solution of 1.1 g of tert-butyl hydroperoxide (70% by weight in chemical water) in 15 g of distilled water and a solution of 0.7 g of HO—CH₂—O—SO₂Na in 15 g of distilled water and continued for a period of 90 minutes.

Thereafter, the batch was cooled down to room temperature and adjusted to pH 7 with 25% by weight of aqueous ammonia.

The dispersion thus obtainable was subsequently filtered through a 120 μm net and thereafter through a 15 μm net.

This gave an aqueous dispersion comprising inventively treated pigment particles. The solids content was 37.8% by weight, the dynamic viscosity was 25 mPa·s, measured at 20° C. The particle diameter distribution of the inventively treated pigments of particulate form obtainable as described above was determined in accordance with ISO 13321 using an Autosizer IIC from Malvern as 137 nm maximum.

I.2d) Adding a mixture of comonomers and further copolymerization

5 minutes after the addition of tert-butyl hydroperoxide and HO—CH₂—SO₂Na as per step I.1c) a mixture of the following composition was added over a period of 90 minutes:

100 g of completely ion-free water

13.4 g of 28% by weight aqueous solution of

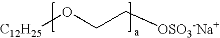

where a=3

6.6 g of 56.5% by weight aqueous solution of sodium di-2-ethylhexyl succinate sulfonate (sodium salt of di-2-ethylhexyl sulfosuccinate)

163.7 g of n-butyl acrylate

75 g of styrene

3.8 g of acrylic acid

7.5 g of compound V a. 1 (“MAMOL”) as a 15% by weight solution in water

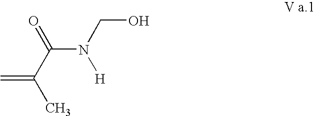

At the same time, the addition was commenced of a solution of 1.25 g of Na₂S₂O₈ in 60 g of water and continued over a period of 105 minutes. The temperature was maintained at 85° C. during the addition.

On completion of the addition, stirring was continued at 85° C. for 30 minutes and then, for deodorization, the concurrent addition was commenced of a solution of 1.1 g of tert-butyl hydroperoxide (70% by weight in water) in 15 g of distilled water and a solution of 0.7 g of HO—CH₂—O—SO₂Na in 15 g of distilled water and continued for a period of 90 minutes.

Thereafter, the batch was cooled down to room temperature and adjusted to pH 7 with 25% by weight of aqueous ammonia.

The dispersion thus obtainable was subsequently filtered through a 120 μm net and thereafter through a 15 μm net. The duration of the filtration was 4 minutes.

This gave an aqueous dispersion comprising inventively treated pigment particles. The solids content was 37.8% by weight, the dynamic viscosity was 25 mPa·s. The particle size distribution of the inventively treated pigment obtainable as described above was determined in accordance with ISO 13321 using a Coulter Counter from Malvern as 137 nm maximum.

The copolymer prepared in a separate run under conditions similar to I.1d) had Tg=−8° C. Measurements of the glass transition temperature T_{g} on the pigment treated according to the present invention gave −2° C.

### EXAMPLE I.2. To I.10.

Example I.1a) to I.1c) was repeated. In step d), second mixture of comonomers according to table 1 was added and copolymerized according to conditions similar to I.1d).

This provided inventively treated pigments in particulate form Nos. 2 to 10.

TABLE 1
Comonomer mixtures of steps I.2d) to I.10d) and also I.1d); numeric values are - unless expressly
stated otherwise - % by weight based on the total amount of comonomers used in step d)

| | | | | | | | MA | | BMA- | | | | | | T_{g} |
|---|---|---|---|---|---|---|---|---|---|---|---|---|---|---|---|
| No. | BA | EHA | EA | MMA | S | AN | Mol | GMA | acac | HPA | AM | MAM | AS | MAS | [° C.] |
| I.2d) | 65.5 | | | | 30.0 | | 3.0 | | | | | | 1.5 | | −8 |
| I.3d) | 63.5 | | | | 31.0 | | | | 5.0 | | | | 0.5 | | −14 |
| I.4d) | 29.0 | 20.0 | | 8.0 | 36.3 | | 4.5 | | | | | | 2.2 | | 12 |
| I.5d) | 37.0 | | | | 48.8 | 8.7 | 3.0 | | | | 0.5 | | | 2.0 | 32 |
| I.6d) | 35.0 | | | 51.8 | | 7.0 | 3.2 | | | | 1.0 | | 2.0 | | 36 |
| I.7d) | 14.5 | | 25.0 | 48.3 | | | | 5.0 | | 4.7 | | 2.5 | | | 35 |
| I.8d) | 20.8 | | 20.0 | 53.0 | | | 2.5 | | | | | 2.5 | 1.2 | | 38 |
| I.9d) | | 5.0 | 32.8 | 50.0 | | | | 5.0 | | 4.7 | | 2.5 | | | 42 |
| I.10d) | 5.0 | | 30.8 | 58.0 | | | 2.5 | | | | | 2.5 | 1.2 | | 53 |
| I.11d) | 10.0 | | 20.0 | 56.8 | | 7.0 | 3.2 | | | | 1.0 | | 2.0 | | 57 |

Abbreviations Used:
BA n-butyl acrylate
EHA 2-ethylhexyl acrylate
EA ethyl acrylate
MMA methyl methacrylate
S styrene
AN acrylonitrile
MAMol N-methylolmethacrylamide
GMA glycidyl methacrylate
BMA-acac 1,4-butanediol monoacrylate-acetylacetate
HPA hydroxypropyl acrylate
AM acrylamide
MAM methacrylamide
AS acrylic acid
MAS methacrylic acid
   I.1d) Adding a Mixture of Comonomers and Further Copolymerization

5 minutes after the addition of tert-butyl hydroperoxide and HO—CH₂—SO₂H from step I.1c) a mixture of the following composition was added over a period of 90 minutes:

130 g of completely ion-free water

12.5 g of 30% by weight aqueous solution of

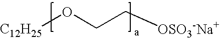

where a=3, 8.3 g of 45% by weight aqueous solution of sodium di-2-ethylhexyl succinate sulfonate (sodium salt of di-2-ethylhexyl sulfosuccinate)

150 g of n-butyl acrylate

88.7 g of styrene

3.8 g of acrylic acid

7.5 g of compound V a. 1 as a 15% by weight solution in water

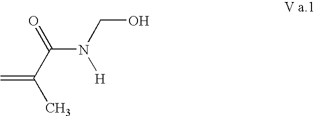

At the same time, the addition was commenced of a solution of 1.25 g of Na₂S₂O₈ in 100 g of water and continued over a period of 105 minutes. The temperature was maintained at 85° C. during the addition.

On completion of the addition, stirring was continued at 85° C. for 30 minutes and then, for deodorization, the concurrent addition was commenced of a solution of 1.1 g of tert-butyl hydroperoxide (70% by weight in water) in 25 g of distilled water and a solution of 0.7 g of NaO—CH₂—O—SO₂H in 25 g of distilled water and continued for a period of 90 minutes.

Thereafter, the batch was cooled down to room temperature and adjusted to pH 7 with 25% by weight of aqueous ammonia.

The dispersion thus obtainable was subsequently filtered through a 120 μm net and thereafter through a 15 μm net.

This gave an aqueous dispersion I.1d) comprising inventively treated pigment in particulate form. The solids content was 34.6% by weight, the dynamic viscosity was 35 mPa·s. The particle size distribution of the inventively treated pigments in particulate form obtainable as described above was determined as 135 nm maximum. The particle size is determined using photon correlation spectroscopy (PCS), also known as quasi elastic light scattering (QELS).

The method of measurement is described in the ISO 13321 standard. A dilute aqueous polymer dispersion (c˜0.005% by weight) is measured.

1.13d) Adding a mixture of comonomers and further copolymerization

Example I.2d) was repeated except that the following monomers were added:

| | |
|---|---|
| 20 g | of styrene |
| 118.7 g | of methyl methacrylate |
| 100 g | of n-butyl acrylate |
| 3.8 g | of acrylic acid |
| 7.5 g | of methacrylamide |

This provided dispersion I.13d) comprising inventively treated pigment in particulate form.

I.14d) Adding a Mixture of Comonomers and Further Copolymerization

Example I.12d) was repeated starting from I.2c) instead of I.1c) to obtain dispersion I.14d) comprising inventively treated pigment in particulate form.

II. Production and Printing of Inventive Inks Comprising Inventively Treated Pigment in Particulate Form

An aqueous dispersion prepared according to Example I.2d) comprising inventively treated pigments in particulate form was used to formulate an ink jet ink in accordance with the following recipe by mixing the following components:

27 g of dispersion of inventively treated pigment in particulate form according to Example I.1d) (corresponds to 102 g of solids)

1.0 g of urea

3.0 g of n-C₄H₉—O(CH₂CH₂O)₃—H

0.25 g of 2,4,7,9-tetramethyl-5-decyne-4,7-diol

16.0 g of glycerol

0.25 g of ethylene glycol

52.5 of completely ion-free water

The mixture was stirred and filled into ink jet cartridges.

This inventive ink had a dynamic viscosity of 3.7 mPa·s and was suitable for printing in commonly used printers.

After insertion of the cartridge in a piezo printer (Epson 3000), the inventive ink was printed onto cotton (100% cotton 250 g/m²).

After air drying and hot air fixation (150° C. for 5 min), the printed cotton possessed excellent performance fastnesses.

| | |
|---|---|
| Rubfastness dry: | 4-5 |
| Rubfastness wet: | 3-4 |
| Washfastness | 4 |

The printed cotton had a pleasantly soft hand.

The rubfastnesses were determined in accordance with German standard specification DIN 54021 and the washfastness in accordance with German standard specification DIN 54011.

II. Textile Coloration with Inventively Treated Pigment in Particulate Form

### II.1. Textile Coloration with Inventively Treated Pigment in Particulate Form According to Example 1

60 g of the pigment dispersion produced according to Example I.1 are admixed with 6 g of a water-soluble random copolymer based on 66% acrylic acid and 34% acrylamide (molar mass M_{w} 60 000 g/mol) and made up to 1 l with demineralized water.

The dyeing liquor thus obtained was padded by means of an HVF 12085 pad-mangle from Mathis onto a 100% cotton fabric. The wet pickup was 85%. The cotton fabric was then dried at 80° C. for 3 min. The cotton fabric was then fixed at 150° C. for 5 min. The fastnesses were determined as:

| | |
|---|---|
| Rubfastness dry, DIN EN ISO 105 X 12 | 4-5 |
| Rubfastness wet, DIN EN ISO 105 X 12 | 4 |
| Washfastness, DIN EN ISO 105 C 03 | 4-5 |
| Helizarin rub-brush wash 3/5 | 4-5 |

### EXAMPLE II.2. To II.10.

Example II.1 was repeated except that the corresponding inventively treated pigments 2 to 10 were used.

In Example II.2, II.6 and II.8, the respective dyeing liquor of the present invention was produced by additionally adding 0.5 equivalent 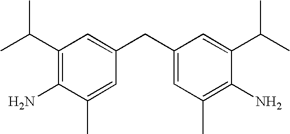
commercially obtainable from Lonza Grp. Lim., Switzerland, a 50% by weight solution in n-butanol.

Textiles colored with pigments treated according to the present invention had excellent haptics. It was found that the textiles colored according to the present invention showed no signs of fading due to crack marks after repeated washing.

Textiles colored with inventively treated pigments in the form of combination shades exhibit excellent brilliance coupled with outstanding levelness.

### II Application Examples: Colorations Of Leather

II.1. Production of Footwear Leather

Commercially available footwear leather crust produced from wet blue was dyed with leather dye (5% by weight, based on crust dry weight, diluted 1:10, 60 min residence time in drum at 35° C.).

Thereafter, inventive dispersion I.12d) was used to carry out a top dyeing:

500 parts by weight of water per 1 part by weight of footwear leather crust, 2.5% by weight (based on crust dry weight) of inventively treated pigment I.12d), diluted 1:10, no further additions, 30 min residence time in drum at 50° C.

Thereafter the float was dropped, the leather washed with 200 parts by weight of water, the float dropped, the leather horsed up for 12 hours, stretched out, suspension dried, staked, milled for 3 hours and strained.

The result was a satisfactory penetration-dyed leather having a visually flawless surface.

III.2. Spray Dyeing of Undyed Chrome-Tanned Cattlehide Crust Leather (Aniline Type Dyeing)

A mixture was prepared from:

| | |
|---|---|
| 200 g | of inventively treated pigment I.14d) in particulate form, |
| 15 g | of surfactant of the formula |
| | cis-CH₃—(CH₂)₇—CH═CH—(CH₂)₈—NH—(CH₂CH₂O)₁₂—OH |
| | and |
| 785 g | of completely ion-free water. |

An undyed chrome-tanned cattlehide crust leather was spray gun sprayed with the above-described mixture to a uniform surface add-on of about 30 g/m² of cattlehide crust leather. Thereafter, the leather was dried at 80° C. and then conditioned for one day in a standard atmosphere.

The following performance properties were found:

| Sprayability: | very good |
|---|---|
| Light fastness (DIN EN ISO 5-B02) | 4 |
| Water drop fastness IUF 420 | 5 |
| Migration fastness to DIN EN ISO 15701 | 4 to 5 |
| Rub fastness dry VESLIC | 1000 |

1. A process for treating pigments in particulate forms the process comprising:
a) mixing a pigment in particulate form with at least one nonionic surface-active substance,
b) dispersing the thus obtainable mixture of pigment in particulate form and nonionic surface-active substance in an aqueous medium,
c) addition polymerizing at least one first monomer or addition copolymerizing a first mixture of comonomers in the presence of a dispersion obtained after b) to form water-insoluble polymer or copolymer at the surface of the pigments in particulate form, and
d) adding at least one second monomer or a second mixture of comonomers and addition polymerizing or copolymerizing.

2. The process according to claim 1 wherein a polymer or copolymer having a glass transition temperature T_{g} of about 0° C. is prepared in d).

3. The process according to claim 1 wherein a polymer or copolymer having a glass transition temperature T_{g} of 30° C. or higher is prepared in d).

4. The process according to claim 1 wherein a polymer or copolymer having a glass transition temperature T_{g} of below 20° C. is prepared in d).

5. The process according to claim 1, wherein the pigments in particulate form are organic pigments.

6. The process according to claim 1, wherein said first monomer is a vinyl-aromatic compound or is a compound of the general formula I 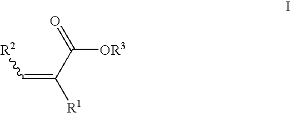
wherein
R¹ is selected from hydrogen, branched or unbranched C₁-C₁₀-alkyl,
R² is selected from hydrogen, branched or unbranched C₁-C₁₀-alkyl, and
R³ is selected from branched or unbranched C₄-C₁₀-alkyl.

7. The process according to claim 1, wherein said first mixture of comonomers is a mixture of at least one vinyl-aromatic compound and at least one compound of the general formula I.

8. The process according to claim 1, wherein R¹ and R² are both hydrogen in one compound of the general formula I.

9. The process according to claim 1, wherein said second monomer added is a monomer of the general formula II 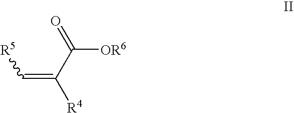
wherein
R⁴ is selected from hydrogen, branched or unbranched C₁-C₁₀-alkyl,
R⁵ is selected from hydrogen, branched or unbranched C₁-C₁₀-alkyl, and
R⁶ is selected from branched or unbranched C₁-C₁₀-alkyl.

10. The process according to claim 1, wherein said second mixture of comonomers comprises at least one monomer of the general formula II.

11. The process according to claim 1, wherein R⁴ is hydrogen or methyl and R⁵ is hydrogen in one compound of the general formula II.

12. The process according to claim 10, wherein said second mixture of comonomers comprises at least one comonomer selected from vinyl-aromatic compound and a compound of the general formula I.

13. The process according to claim 1, wherein d) is carried out in the presence of up to 5% by weight, based on said second mixture of comonomers, of at least one compound of the formula V a or V b 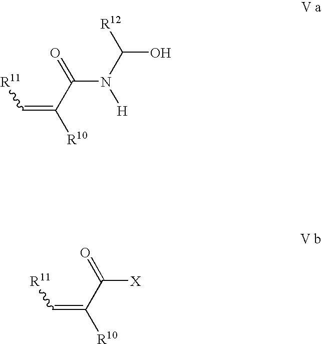
wherein
R¹⁰ to R¹² are the same or different and are each selected from hydrogen and branched or unbranched C₁-C₁₀-alkyl,
X is selected from hydrogen, glycidyl, protonatable groups having tertiary amino groups and enolizable groups having 1 to 20 carbon atoms.

14. Treated pigments in particulate form, obtainable by the process according to claim 1.

15. A method for producing colorant preparations, comprising:
providing treated pigments in a particulate form according to claim 14 to a colorant preparation.

16. A method for producing inks for the ink jet process, comprising:
providing treated pigments in a particulate form according to claim 14 to an ink composition.

17. A method for producing inks for the ink jet process, comprising:
providing an aqueous dispersions of treated pigments in a particulate form according to claim 14 to an ink composition.

18. Inks for the ink jet process according to claim 16.

19. A process for printing substrates by the ink jet process using inks according to claim 18.

20. The process according to claim 19 wherein said substrates are textile substrates.

21. Printed substrates obtainable according to claim 19.

22. A method for coloration of a textile or a leather, the method comprising:
providing treated pigments in a particulate form according to claim 14.

23. A process for coloration of textile, the process comprising:
treating textile substrates with at least one treated pigment in a particulate form according to claim 14.

24. A dyeing liquor for textile dyeing, comprising at least one treated pigment in a particulate form according to claim 14.

25. A print paste for textile printing, comprising at least one treated pigment in a particulate form according to claim 14.

26. A colored textile substrate obtainable by a process according to claim 14.

27. (canceled)

28. A process for coloration of leather, comprising:
treating predyed leather with at least one treated pigment in a particulate form according to claim 14.

29. An aqueous bottoming dispersion comprising:
at least one treated pigment in a particulate form according to claim 14; and
at least one of the following constituents: at least one wax, at least one biocide, or at least one binder.

30. Colored leather obtainable by a process according to claim 28.

31. Footwear produced from colored leather according to claim 30.
